(19) United States
(12) Patent Application Publication
(10) Pub. No.: US 2013/0241237 A1
(43) Pub. Date: Sep. 19, 2013

(54) VEHICLE BODY

(71) Applicants: John Dziuba, West Bloomfield, MI (US); Brian Enck, Sterling Heights, MI (US); William Griese, Allen Park, MI (US)

(72) Inventors: John Dziuba, West Bloomfield, MI (US); Brian Enck, Sterling Heights, MI (US); William Griese, Allen Park, MI (US)

(73) Assignee: NAVISTAR DEFENSE ENGINEERING, LLC, Lisle, IL (US)

(21) Appl. No.: 13/608,614

(22) Filed: Sep. 10, 2012

Related U.S. Application Data
(60) Provisional application No. 61/533,883, filed on Sep. 13, 2011.

(51) Int. Cl. B62D 25/00

(52) U.S. Cl. CPC B62D 25/00
USPC 296/193.04

(57) ABSTRACT

A modular vehicle frame structure assembly, which combines a monocoque cabin structure with separately attachable space frame structures, is disclosed. The modular vehicle body assembly includes a monocoque cabin structure, a front frame section and a rear frame section, wherein the front and rear frame sections secure separately to the respective front and rear sections of the cabin structure and extend longitudinally therefrom forming a modular vehicle body with the cabin structure. The modular vehicle frame assembly is useful in the construction of light weight, low-profile military vehicles.

### CROSS-REFERENCE TO RELATED APPLICATIONS

This application claims the benefit of U.S. Patent Application Ser. No. 61/533,883 filed on Sep. 13, 2011.

### TECHNICAL FIELD

The present assembly relates to the structures forming the body of a vehicle. More specifically, the present assembly relates to construction of a blast resistant vehicle having a low profile and reduced weight, using a combination of monocoque and space frame construction.

### BACKGROUND

Vehicle frames provide a platform upon which a body can be supported and other components of a vehicle can be mounted. Generally, in the light automotive world, the vehicle frame more closely emulates a space frame type of structure, giving it a light weight, low-profile package, increasing the speed, agility and fuel economy of the vehicle, while decreasing the material cost. Heavier vehicles, such as trucks typically use body-on-frame or a ladder frame assembly. A ladder frame assembly includes a pair or longitudinally extending side rails that are joined together by a plurality of transversely extending cross-members. The cross-members connect to the two side rails together and provide lateral and torsional stiffness to the ladder frame assembly. Typically, the two side rails are solid pieces of steel and are substantially C-shaped in cross-section. Thus, the resulting frame is heavy, and the addition of any armored protection, such as for a vehicle for military use, makes the vehicle even heavier.

Another form of vehicle construction is monocoque, which is a construction technique that supports structural load by using an object's external skin, as opposed to using an internal frame or truss that is then covered with a non-load-bearing skin. The term is also used to indicate a form of vehicle construction in which the body and chassis form a single unit. Vehicles requiring a high degree of armored protection, such as tanks, often use a monocoque hull construction taking advantage of the material strength of the armor to act as structure.

In vehicles intended for military applications, greater mobility, higher speeds, low weight and low profile become quite important. However, there is still a requirement to provide armored protection for blast resistance to the occupants of the vehicle, while providing the previously-stated features. This is particularly true for the family of light tactical vehicles (FLTV), which are common in today's military fleet. Combining an armored monocoque construction for a personnel cabin, with a separately attached space frame-type construction for the chassis, engine and power train compartments, achieves a blast protection vehicle having both a low profile and reduced weight. This modular construction also provides assembly advantages, such as reducing plant line space, a more efficient final assembly process and improved dimensional integrity.

### SUMMARY

There is disclosed herein an structure and assembly for constructing a vehicle frame for a reinforced military vehicle, which avoids the disadvantages of prior structures while affording additional structural and costs advantages

Generally speaking, the present assembly relates to a modular vehicle frame structure, which combines a monocoque cabin structure with separately attachable space frame structures.

In an embodiment, the modular vehicle body assembly comprises a monocoque cabin structure, a front frame section and a rear frame section, wherein the front and rear frame sections secure separately to the respective front and rear sections of the cabin structure and extend longitudinally therefrom forming a modular vehicle body with the cabin structure.

In another embodiment, modular architecture for forming a vehicle body for a military vehicle, is disclosed. The vehicle body comprises a cabin module for occupants of the vehicle, and at least one longitudinally extending structural member for supporting a powertrain, wherein the structural member is attached to the cabin module forming a modular body assembly.

These and other features and advantages of the modular vehicle body assembly can be more readily understood from the following detailed discussion with reference to the appended drawing figures.

### BRIEF DESCRIPTION OF THE DRAWINGS

FIG. 1 is a perspective front view of the modular vehicle body assembly of the present disclosure;

FIG. 2 is a perspective rear view of the modular vehicle body assembly of the present disclosure;

FIG. 3 is a perspective side view of the modular vehicle body assembly of the present disclosure;

FIG. 4 is a perspective view of the monocoque cabin structure of the present disclosure;

FIG. 5 is a perspective view of the front and rear frame sections of the present disclosure;

FIG. 6 is a perspective view of the front and rear frame sections of the present disclosures illustrating lower frame and suspension cradles; and,

FIG. 7 is a side view of the front and rear frame sections of the present disclosures illustrating lower frame and suspension cradles.

### DETAILED DESCRIPTION

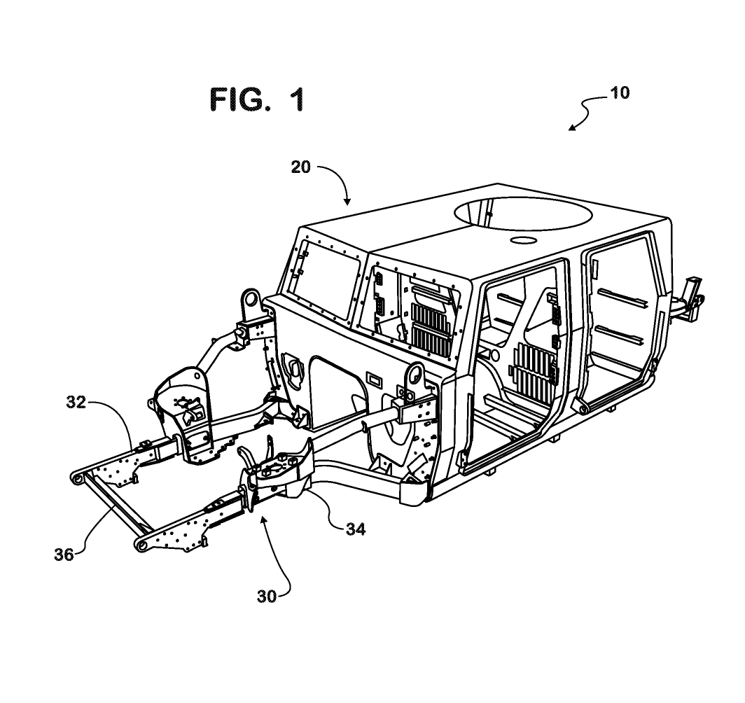

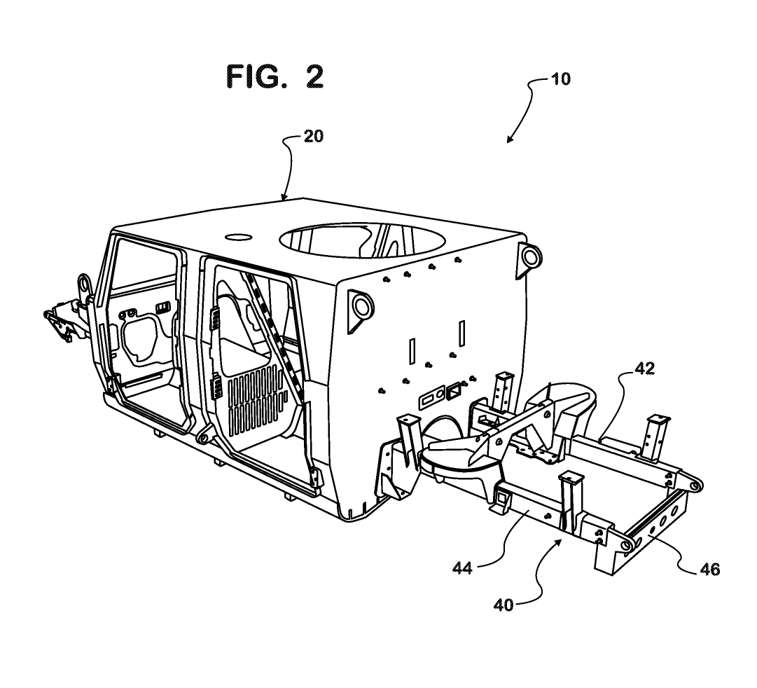

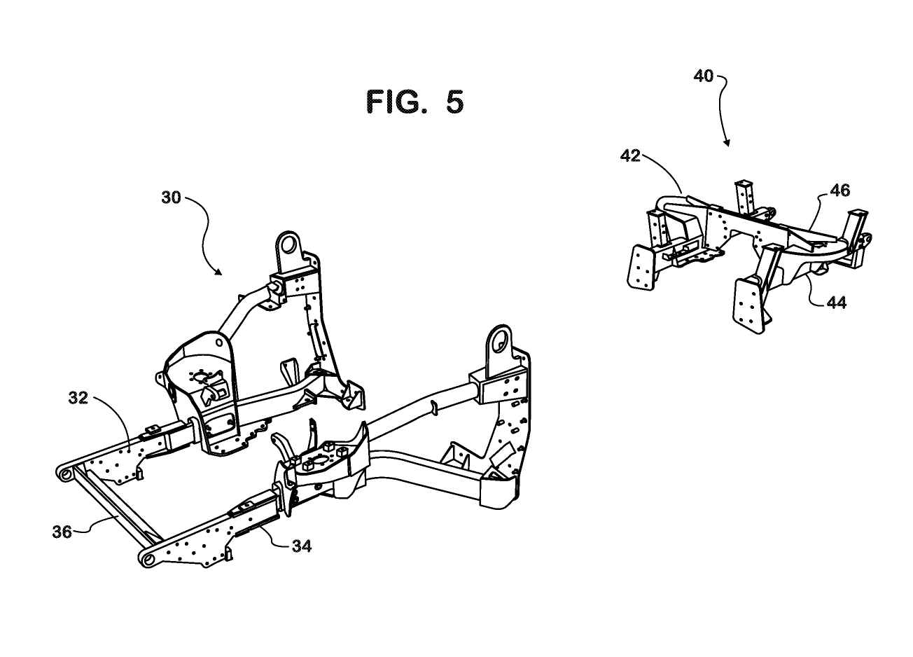

Referring to FIGS. 1-7, there is illustrated an embodiment of the modular vehicle body assembly generally designated by the numeral 10, as well as the components thereof. Vehicles, and in particular, vehicles for military use, require a high degree of armored protection, which can add considerable weight to an already large vehicle frame. The present assembly provides for a modular vehicle body that combines a cabin module 20 with separate front frame 30 and rear frame 40 sections attached to the respect front and rear areas of the cabin module, resulting in a vehicle with a reinforced personnel cabin having a lighter weight and lower profile frame structure.

Use of space frame type of construction for vehicle body frames is known. Tubular space frame construction is desired to provide a frame with a light weight and low profile package. In addition, vehicle body frames are generally constructed as one continuous structure, including the front, rear and passenger sections of the vehicle.

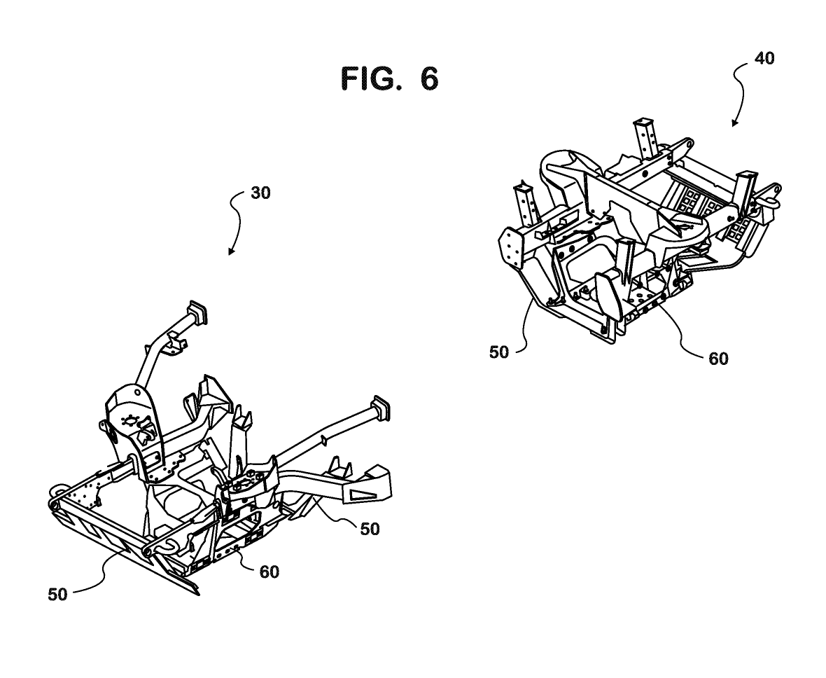

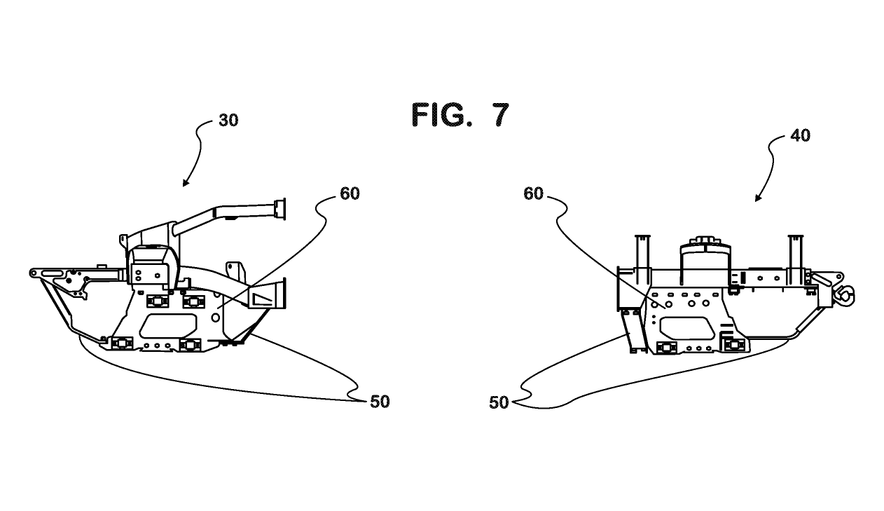

The present assembly 10 incorporates an embodiment of a space frame construction. However, instead of constructing the frame for the present assembly 10 as single, unified structure, it utilizes a separate, modular front frame section 30 and a separate, modular rear frame section 40 (FIGS. 1, 2 and 5). The front frame section 30 and rear frame section 40 also include a lower frame 50 and a suspension cradle 60 (FIGS. 6, 7). Both the front and rear frame sections incorporate the space frame type of tubular construction found in a low profile, light weight vehicle. In this embodiment, the front frame section 30 includes first and second rail members 32, 34 parallel to one another with a cross member 36 extending between and connecting the first and second rail members. Similarly, the rear frame section 40 first and second rail members 42, 44 parallel to one another with a cross member 46 extending between and connecting the first and second rail members. Although one embodiment of the front frame section 30 and rear frame section 40 is shown, it should be understood that the frame sections can include any number of rail members and cross members, depending on the structural requirements of a particular vehicle. Although not shown, the front and rear frame sections 30, 40 support a chassis and powertrain components, including an engine and front and rear suspension assemblies, transmission, transfer case, front and rear axles, driveshafts, batteries, fuel tank, air tank, load platform, electronic controllers, steering gear and shafts, cooing system, body clip (grille, hood, headlights), winch, and tow bar for the vehicle.

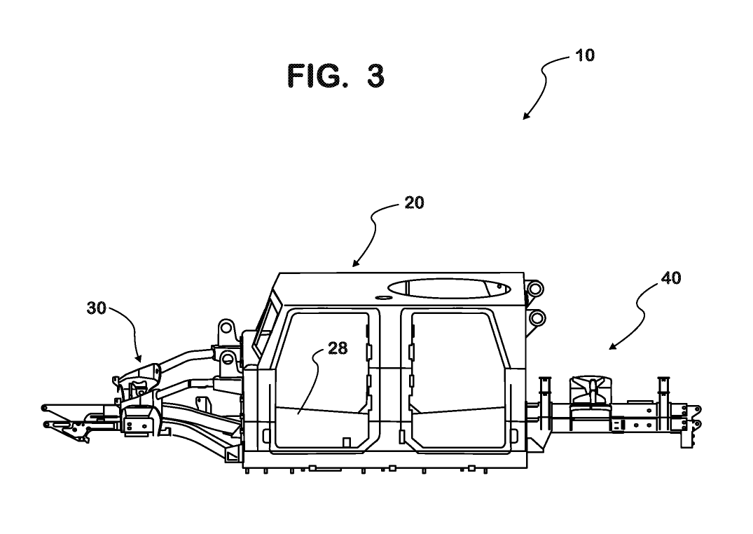

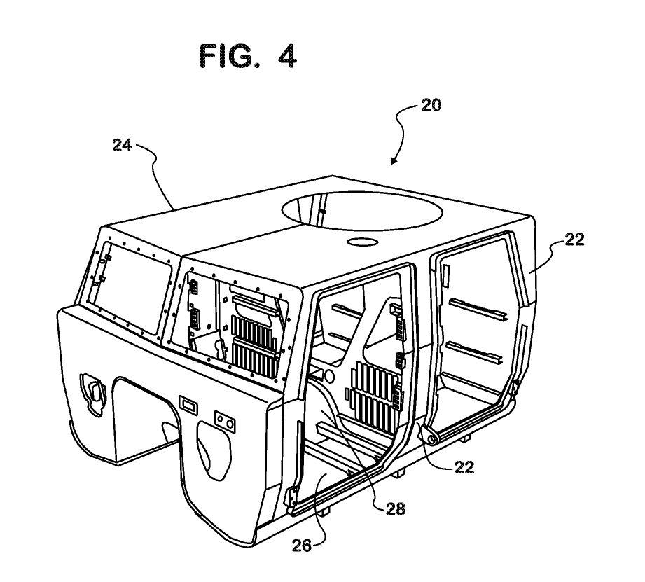

Referring to FIGS. 3 and 4, the front and rear frame sections 30, 40 are attached to a cabin module 20. The cabin module 20 may also be referred to as a personnel cabin. Attachment of the front and rear frame sections to the cabin module can be accomplished using any known attachment means, including welding, bolting, adhesives, or any combination of attachment means. Military vehicles requiring a high degree of armored protection for the occupants of the vehicle often use a monocoque hull construction to take advantage of the material strength of the armor to act as a structure. The present assembly 10 incorporates this concept in the cabin module 20. In the embodiment shown in FIG. 4, the cabin module 20 uses monocoque construction, meaning that it is a shell of unitary construction including sides 22, top 24 and floor 26. In this manner, the cabin module 20, which is constructed from blast resistant armored material, provides armored protection for the occupants of the vehicle with a structure having lower weight and profile.

In addition to the monocoque construction, the cabin module 20 may include other structural features to enhance its blast protection. For example, as shown in FIGS. 3 and 4, the floor portion 26 of the cabin module 20 is configured generally having a heightened area 28 along a central longitudinal plane area, with lower areas forming the actual floor of the cabin where occupants rest their feet. The heighted area 28 may include a variety of configurations including curvilinear, saddle and sinusoidal shapes. The heightened areas 28 create deflection faces and venting openings, which deflect and vent the blast and resulting fragmentation away from the interior of the cabin, as well as, separation distances for separating the interior of the cabin from the blast force. The high and low areas of the cabin module 20 act to dissipate the force of the explosion.

The modular construction of the present assembly 10 achieves a lower profile, reduced weight vehicle useful for military operation, while providing armored protection for the occupants. The modular construction also permits customization construction of a particular vehicle. Elimination of the frame rail under the cabin means the vehicle is capable to meet requirements for transport of sea-going vessels. As shown in FIGS. 6 and 7, the present assembly includes suspension structures, such as a lower frame 50 and a suspension cradle 60, which are integrated into the vehicle architecture completing overall structural support required for automotive loads, vehicle tiedown loads for shipping by any suitable means including by airplane, helicopter, ship, railroad, and/or truck, and assisting in recovery from field, ditch, stream, etc.

Modular construction provides an assembly plant advantage by reducing plant line space, improving dimensional integrity and a robust final assembly process. Specifically, modules can be built with individual attention to detail so a smaller number of modules are put together on the assembly line instead of a large number of detail parts, minimizing the number of simple fixture avoiding large complex fixtures. Ultimately this provides a completed vehicle with a high degree of dimensional accuracy minimizing the amount of adjustment necessary to the completed vehicle for assembly and alignment. This is also important for service when damaged parts are removed, allowing the replacement parts to fit perfectly with minimum final adjustment required.

What is claimed is:

1. A modular vehicle body assembly comprising:
a monocoque cabin structure;
a front frame section; and,
a rear frame section, wherein the front and rear frame sections secure separately to the respective front and rear sections of the cabin structure and extend longitudinally therefrom forming a modular vehicle body with the cabin structure.

2. The modular vehicle body assembly of claim 1, wherein the monocoque cabin structure further comprises an armored construction.

3. The modular vehicle body assembly of claim 1, wherein the front and rear frame sections form a chassis.

4. The modular vehicle body assembly of claim 1, wherein the front frame section further includes first and second rail members parallel to one another with a cross member extending between and connecting the first and second rail members.

5. The modular vehicle body assembly of claim 4, wherein the front frame section houses a front wheel and suspension assembly and an engine compartment.

6. The modular vehicle body assembly of claim 1, wherein the rear frame section further includes first and second rail members parallel to one another with a cross member extending between and connecting the first and second rail members.

7. The modular vehicle body assembly of claim 6, wherein the rear frame section houses a rear wheel and suspension assembly.

8. A modular architecture for forming a vehicle body for a military vehicle comprising:
a cabin module for occupants of the vehicle;
at least one longitudinally extending structural member for supporting a powertrain for the vehicle, wherein the structural member is attached to the cabin module forming a modular vehicle body assembly.

9. The vehicle body of claim 8, wherein the cabin module comprises a monocoque hull construction.

10. The vehicle body of claim 9, wherein the monocoque structure further comprises a blast resistant structure for protecting occupants of the cabin.

11. The vehicle body of claim 8, wherein the structural member further comprises a front frame section attachable to a front portion of the cabin module and a rear frame section attachable to a rear portion of the cabin module.

12. The modular vehicle body of claim 10, wherein the front and rear frame sections form a chassis of the vehicle body.
